(19) United States
(12) Patent Application Publication
(10) Pub. No.: US 2026/0277235 A1
(43) Pub. Date: Sep. 17, 2026

(54) AUTONOMOUS VEHICLE FOR POULTRY FARMING FIT FOR CORRALS WITH ELEVATED BARRIERS ON THE TERRAIN

(71) Applicant: APPELIE LLC, Dover, DE (US)

(72) Inventor: Lucas Jagodnik, Alpharetta, GA (US)

(73) Assignee: APPELIE LLC, Dover, DE (US)

(21) Appl. No.: 19/079,799

(22) Filed: Mar. 14, 2025

(51) Int. Cl. G05D 1/648; G05D 1/628; G05D 105/15; G05D 107/20; G05D 109/15; G05D 111/10; G05D 111/50

(52) U.S. Cl. CPC G05D 1/648; G05D 1/628; G05D 2105/15; G05D 2107/21; G05D 2109/15; G05D 2111/10; G05D 2111/52

(57) ABSTRACT

An autonomous vehicle, preferably acting as an autonomous robot for operation in animal farming enclosures, such as poultry farming sites, with the capacity of moving autonomously in environments with the presence of elevated barriers on the terrain, for example corrugated pipes across the corridors. The vehicle includes a chassis supported by a set of wheels, with at least one wheel configured as the climbing engagement wheel. This special wheel has perimeter paddles, at least one of which has a radial lug designed to fit with interference in a groove included in the barriers present on the enclosure, generating an efficient climbing or crawling effect. Hence, this vehicle results highly effective to overcome obstacles, optimizing its mobility within a farming environment.

### TECHNICAL FIELD

The present invention relates to the field of technology of autonomous vehicles for specific environments, such as robot-type autonomous vehicles programmed for specific tasks. In particular, the invention herein focuses on the performance of animal raising tasks within breeding enclosures, such as corrals and barns. More specifically, it refers to a vehicle suitable for poultry farming and inspection, with the capacity to pass over elevated barriers on the terrain, such as anti-migratory barriers, and the most commonly used: corrugated pipes.

### BACKGROUND ART

There is an increasing demand by society for responsible animal farming, with proper care and attention given to animals along their full life cycle and ensuring proper farming conditions. However, the tasks that ensure responsible farming, such as continuous monitoring of corrals, animal health care, early management of dead animals, soil conditioning, feeding supervision, and water supply are time-consuming tasks that require continuous effort in environments that are naturally prone to becoming especially harmful for human health.

A typical example of the above-mentioned harmful conditions in this type of enclosures or corrals is the presence of urine and feces, with the resulting concentration of gases like ammonia.

The continuous care and physical effort required for the above-referenced farming tasks have made corralled animal farming more and more unappealing to the newer generations, causing labor shortage when it comes to these essential tasks.

For example, when it comes to intensive poultry farming, breeding and fattening of the animals is performed within corrals that are monitored during periods of up to two months. Tasks performed include disinfection, cleaning and preparing the corrals before the arrival of the animals, and temperature and moisture control during each life stage.

These corrals are poultry farming controlled enclosures that allow breeding and optimize productivity. They generally adopt rectangular shapes and their measurements may vary. For example, they may be 150 meters long by 15 meters wide (approximately 500 ft. by 50 ft.), although they may be smaller or larger, according to the appropriate needs, with no particular limitation.

In these corrals, the main water supply and feed lines are laid out longitudinally, i.e., parallel to the longest side. Water dispensers are set out at regular intervals so that animals can access clean and fresh water at all times. In particular, feed lines are automated to dispense grains along their full length, on feed trays.

Said water supply and feed lines outline passageways (corridors) where animals carry out their daily activities. These corridors offer a structured environment that allows for monitoring and efficient management of animals, in this case, poultry.

In order to ensure the well-being of animals, soil quality is essential. The breeding cycle must start on a dry substrate, given that the soil deteriorates with the passing of time due to urine and feces. This initial care of the soil ensures the appropriate safety conditions for animal growth.

As one skilled person well knows, in animal breeding enclosures, soil is the first major challenge for an autonomous wheeled vehicle needing to operate within the corrals. This is because a wheeled vehicle may slip or lose traction due to dry and loose material or may get stuck due to moist and sticky material, owing to the presence of feces and urine, among other factors. Consequently, the behavior and reliability of an autonomous vehicle inside a corral may be very unpredictable, as may be the very condition of the soil, given that it may be dry and loose or, on the contrary, sticky and muddy.

Currently, due to the lack of a completely reliable autonomous vehicle for farming labor, farmers must continue to devote much time and effort to complete their daily rounds. This prevents them from prioritizing other activities, which very often means the neglect of other crucial tasks that would significantly contribute to animal well-being and overall productivity. Among the tasks that are often left behind are actions so vital as stimulating animal movement in order to promote muscle exercise and bone formation; performing bedding treatments or scarification to reduce moisture; emptying certain sectors temporarily to allow soil ventilation; monitoring the behavior and poses of animals and interpreting their noises; and controlling conditions such as temperature, humidity, water leaks and regular food supply.

Such tasks could very well be performed routinely and continuously by an autonomous vehicle without the need for supervision. However, it would be necessary to have a vehicle that could ensure uninterrupted movement wherever necessary in the corrals. Until today, this has remained a true challenge for both designers and manufacturers.

A key aspect in animal breeding is to maintain high biosafety standards. Increasing farming personnel would not be a convenient solution, as the main goal is to avoid the intrusion of people and, in particular, to prevent cross-contamination among the different corrals. This safety measure even concerns visits by technical experts, such as veterinarians, production managers, nutritionists, geneticists, and other specialists, who must undergo careful examination for such high biosafety standards to be maintained. The use of an exclusive autonomous vehicle for each corral shall prevent cross-contamination.

Therefore, having an autonomous vehicle with the capacity to perform farming tasks within a breeding enclosure, i.e. breeding corrals, constitutes a real need. Today, it is a major challenge to find a type of autonomous vehicle which can reliably move on the difficult corral terrain, and specifically, there exists the need for autonomous vehicles that are capable of climbing over obstacles such as elevated barriers on the terrain.

For the purpose herein, an “elevated barrier on the terrain” shall be understood to be an obstacle, such as a barrier laid out transversely on the path or corridor and that is generally across the expected trajectory of animals or vehicles (for instance, in the corridors), directly or indirectly interfering with their normal circulation. An elevated barrier on the terrain will be understood to be a physical structural element laid upon or slightly over the level of the terrain or passageway in a manner that becomes physical interference that prevents, limits or regulates the circulation of vehicles, persons, animals, or any moving object. Said barrier may adopt different shapes, sizes and materials, and may be fixed, movable or removable, depending on its specific function.

An elevated barrier on the terrain serves as an obstacle or delimitation to prevent movement, define specific areas, or protect certain spaces. It may be comprised of rigid, flexible, regular or irregular objects, including smooth, corrugated or protruding surfaces. It may be used in multiple contexts, as anti-migratory barriers for animals or delimitation for specific areas.

For the purpose of the invention herein, there is a type of elevated barrier on the terrain that results in an especially difficult to surpass by an autonomous vehicle, like the object of the present invention, and it is the corrugated pipe, when acting as an elevated barrier on the terrain.

A corrugated pipe is a tube with an external undulating or ridged surface with grooves around its circumference, designed to improved mechanical resistance, flexibility or adaptability to different uses. Unlike smooth-surfaced tubing, its corrugated structure makes it capable of supporting loads, absorbing impacts and better adapting to irregular terrains. Depending on the material and the use, it may be employed for conducting fluids, protecting cables or even used as a protection or delimitation structural piece. In agricultural, industrial or construction environments, corrugated pipes are valued for their durability and versatility, as they can serve as barriers, drainage pipes, or support, according to the specific need. Hence, their use is very widespread and they are frequently found in corrals.

Elevated barriers on the terrain, whether placed intentionally or inevitably, act as anti-migratory barriers, and they are more effective as the pipe diameter increases.

Therefore, barriers are placed in corrals perpendicular to the length of the corral, with the aim of dividing it into different zones, that is, cutting long passageways or longitudinal corridors. This way, they serve as anti-migratory barriers, and they are used to prevent animals from displacing massively, which is a good function in itself. However, the disadvantage is that they constitute a challenging obstacle to an autonomous vehicle attempting to move along the corral and needing to overcome such barriers.

Some typical corrugated pipes used in corrals are Polyvinyl Chloride (PvC) tubes with nominal measurements of 8″, 10″ and 12″ (diameters of about 20 cm, 25 cm and 30cm), only as a measurement reference, without any limitation.

In short, an autonomous vehicle for poultry farming in corrals must be sufficiently reduced in size so that it can move in narrow spaces and ride alongside poultry. The latter, usually increases the difficulty for wheeled vehicles to overcome relatively large, elevated barriers on the terrain, especially corrugated pipes.

Corrugated pipes tend to accumulate soil particles in their grooves, which makes it even more difficult to climb over and move over them, as their surface becomes more slippery than that of other barriers. In consequence, a vehicle that needs to overcome anti-migratory barriers must also be capable of operating in a predictable manner given the variable conditions of dry and slippery or moist and sticky soil.

It is then possible to state that there is still a need for an autonomous wheeled vehicle capable of performing efficiently within a corral with all the above-referenced limitations and challenges, especially having the capability of overcoming elevated barriers on the terrain.

### SUMMARY OF INVENTION

It is an objective of the invention to provide an autonomous vehicle suitable for poultry farming in corrals that saves time otherwise wasted on monitoring its performance, especially regarding effective and autonomous movement inside work enclosures.

The aim of the invention herein is for such an autonomous vehicle to have the capability of moving without difficulty along the corral, effectively crossing elevated barriers on the terrain, such as anti-migratory barriers, featuring the capacity to effectively climb over corrugated pipes laid out across corral passageways.

The user shall find other additional objectives evident, and these can be deduced by a skilled person in view of the teachings of this document.

### BRIEF DESCRIPTION OF DRAWINGS

For greater clarity and better understanding of the object of the invention herein, several Figures illustrate it representing at least one preferred, non-limiting embodiment, as an example, where:

FIG. 1 is a perspective view of one first preferred, non-limiting example of embodiment of an autonomous vehicle according to the invention herein;

FIG. 2 is a perspective view of the vehicle illustrated in FIG. 1 with several covers that form its casing remove;

FIG. 3 is a perspective view illustrating a corrugated pipe laid out on the ground and an autonomous vehicle according to the invention herein at the moment it starts climbing on the corrugated pipe;

FIG. 3A is a close-up view of the area of interaction of one of the wheels with the corrugated pipe;

FIG. 4 is a front view illustrating the interaction of the wheels of an autonomous vehicle according to the invention herein with a corrugated pipe;

FIG. 5 is a perspective view of one of the wheels of the autonomous vehicle in one first preferred embodiment;

FIG. 6 is a perspective view of a simplified diagram of an autonomous vehicle in a second example of embodiment illustrating an alternative wheel distribution;

FIG. 7 is a partial exploded perspective view of an autonomous vehicle wheel according to the first preferred embodiment in FIG. 5;

FIG. 8A is an embodiment variant of the paddle and lug for an autonomous vehicle according to the invention herein;

FIG. 8B is another embodiment variant of the paddle and lug for an autonomous vehicle according to the invention herein;

FIG. 8C is another embodiment variant of the paddle and lug for an autonomous vehicle according to the invention herein;

FIG. 8D is another embodiment variant of the paddle and lug for an autonomous vehicle according to the invention herein;

FIG. 8E is another embodiment variant of the paddle and lug for an autonomous vehicle according to the invention herein;

FIG. 9A illustrate a stage of maneuvering by climbing and riding over a corrugated pipe, in a series of relative positions of the autonomous vehicle as per the present invention;

FIG. 9B illustrate another stage of maneuvering by climbing and riding over a corrugated pipe, in a series of relative positions of the autonomous vehicle as per the present invention;

FIG. 9C illustrate another stage of maneuvering by climbing and riding over a corrugated pipe, in a series of relative positions of the autonomous vehicle as per the present invention;

FIG. 9D illustrate another stage of maneuvering by climbing and riding over a corrugated pipe, in a series of relative positions of the autonomous vehicle as per the present invention;

FIG. 9E illustrate another stage of maneuvering by climbing and riding over a corrugated pipe, in a series of relative positions of the autonomous vehicle as per the present invention; and

FIG. 9F illustrate another stage of maneuvering by climbing and riding over a corrugated pipe, in a series of relative positions of the autonomous vehicle as per the present invention.

### DESCRIPTION OF EMBODIMENTS

In order to provide the person skilled in the art with a complete description of the present invention, the same will be described below in detail and with the aid of the accompanying Figures.

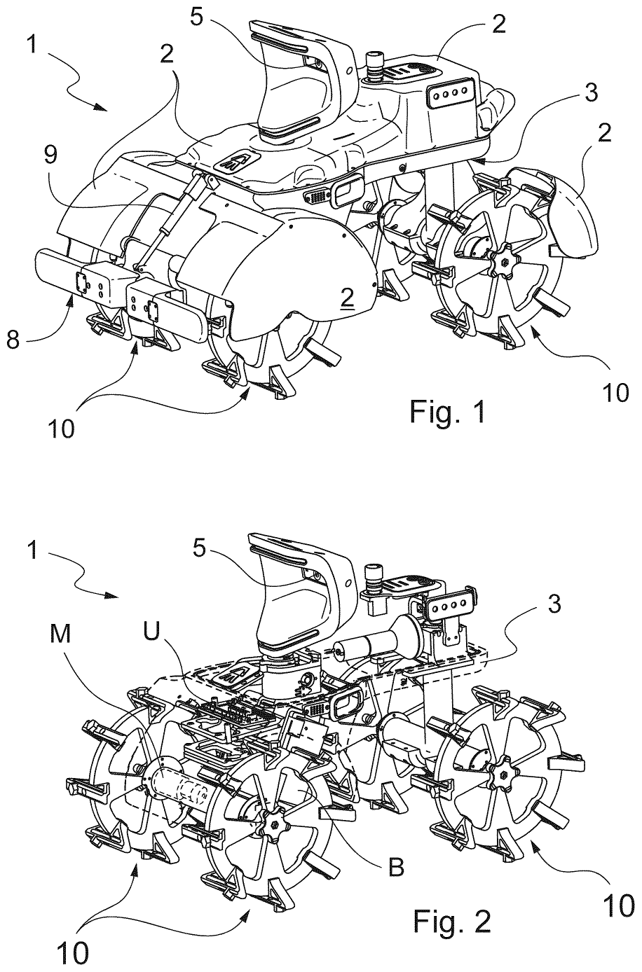

FIG. 1 shows an overall illustration by way of a preferred, non-limiting first example, very representative of the invention herein according to the inventors preferred embodiment of what shall hereinafter be simply referred to as “autonomous vehicle (1)”. This Figure illustrates several vehicle casings (2) that make up what could be considered the casing or overall physical protection for the various functional components of the vehicle. The casing generally adopts a curved geometry and it is comprised of mostly washable materials on the surface. Likewise, the preferred materials must resist the action of chemicals frequently used for disinfection, required on the field where the vehicle must operate.

The inventors have conceived this autonomous vehicle (1) especially for poultry farming and breeding in corrals-enclosed spaces. However, as skilled people shall appreciate, this autonomous vehicle shall also be suitable for a variety of animal farming scenarios.

For purposes of disclosure, in FIG. 2 the same autonomous vehicle (1) as in FIG. 1, this time, is showed without the external casings (2) and without other accessories, in order to show the interior in detail, comprised of a chassis (3) supported by a set of wheels (10).

Said chassis (3), regardless of its particular shape, constitutes the structure or main frame designed to support at least one rechargeable power source (B) to power the autonomous vehicle and a control unit (U) to command the operation of the autonomous vehicle. This autonomous vehicle may have other components that are known to those well versed in the art, of relative secondary importance in relation to the protection of the invention herein, and that will later on be referenced to, such as sensors, lights, among other components.

The above-mentioned wheels (10) supporting the chassis (3) are responsible for allowing the movement of the autonomous vehicle when powered by at least one motor device (M), such as continuous current motor, a step-by-step motor, or any other kind of motor, namely, preferably electric, so that the wheels can turn as intended with the required power.

Said at least one motor device (M) powers each one of the wheels (10). Preferably, each one of the wheels (10) in the vehicle has one individual motor device (M). This way, steering and speed of the autonomous vehicle can be attained by simply modifying the speed of each of the individual motors (M) independently. This way, the vehicle can dispense with an accessory mechanism for steering. Nevertheless, as those well versed in the art shall comprehend, it is not impossible for the autonomous vehicle to have a single motor device or other setups, as long as the autonomous vehicle is capable of moving in any desired direction within the work space.

While in the first example of embodiment the autonomous vehicle has four wheels (10), that is, two front wheels, which for the purpose herein set forth are considered as the “climbing engagement wheels” (10s), and two rear wheels (10t), other configurations are possible as long as the vehicle is capable of properly supporting the chassis (3) and the remaining components away from the ground and in a suitable condition for operation and conservation.

Therefore, a skilled person can understand that, as a minimum necessary condition for said autonomous vehicle (1) operation there is at least one climbing engagement wheel (10s). This embodiment is shown in FIG. 6, and the particular arrangement of the wheels is not limited to the one shown, provided that it does not interfere with maneuvering over the elevated barrier on the terrain, as will be discussed later herein.

Such as it was described in the Prior Art, and as the inventors have been able to confirm with successive trials, it is not enough for an autonomous vehicle (1) to have any kind of wheel or only wheels that have more or less deep tracks, as it is a real issue for vehicles in this corral environment to overcome obstacles due to slippery conditions when attempting to climb the above-referenced elevated barriers on the terrain, and the more so when such obstacles have been placed intentionally as real anti-migratory barriers (i.e., really elevated on the terrain), for instance, corrugated pipes.

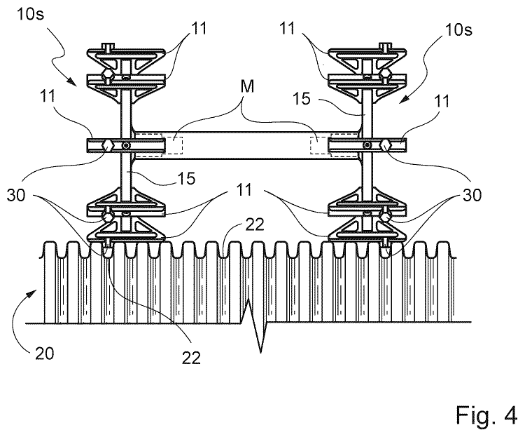

To that end, the autonomous vehicle (1) according to the invention herein, and as better illustrated in FIGS. 4, 5 and 7, has at least one climbing engagement wheel (10s), a set of perimeter paddles (11) effectively distributed along the perimeter of said climbing engagement wheel (10s), where the perimeter paddles (11) are preferably and uniformly assembled on the perimeter of a disc (15).

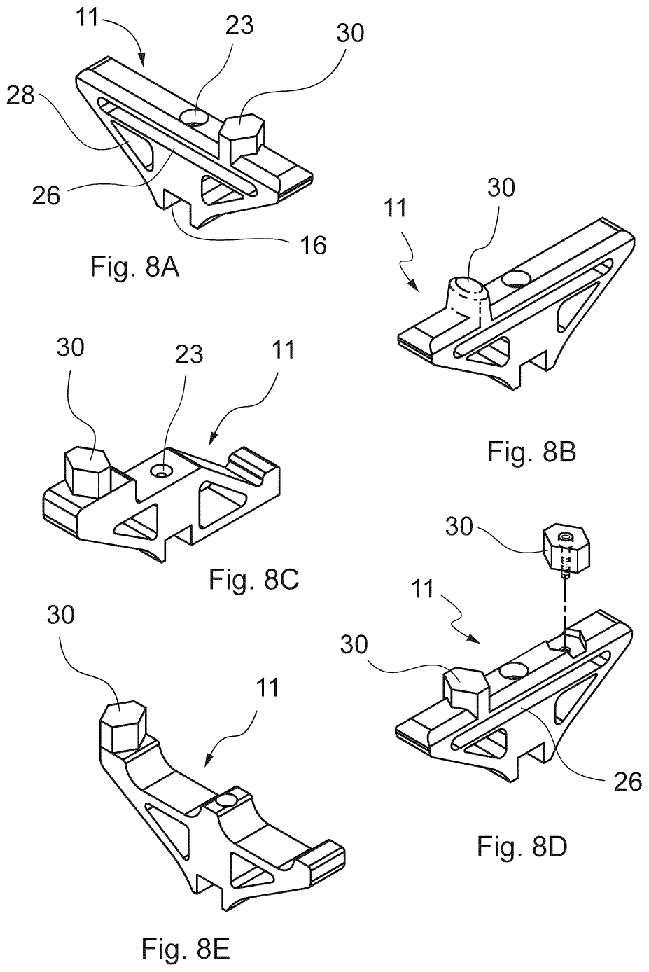

As shall be apparent for a skilled person, the perimeter paddles (11) can be connected in detachable fashion to said disc (15) which allows for a greater capacity of adaptation to the demands of the environment. For example, the user can get several sets of paddles of several geometries (see FIGS. 8A and 8E) or may modify the number of paddles distributed along the disc perimeter (15) to set up the climbing wheel (10).

Preferably, and as shown by way of an example of the invention herein, eight perimeter paddles (11) are uniformly distributed on the disc perimeter (15), which in the case of a 30cm-diameter wheel (about 12 inch-diameter) allows for an efficient balance between weight and number of components, and allows for sufficient support surface on the ground.

The support surface on the ground is defined both by the support perimeter of the disc itself (15) and the external part of the perimeter paddles (11). Nevertheless, the number of perimeter paddles (11) on a wheel (10) shall be modified as convenient, for instance, depending on the number of wheels and the weight distribution, considering that the fewer components added to the wheel, the lighter it should be, as well as easier to keep clean.

Selecting a certain wheel diameter (10), among other things, allows for proper clearance off the ground in the lower part of the chassis and clearance between the wheels of the autonomous vehicle (1) so as to prevent the autonomous vehicle (1) from resting the ground and to avoid blocking its movement as it rides over the elevated barriers on the ground, such as the above-referenced corrugated pipe (20).

The geometry ratio needed for this, i.e., safe clearance off the ground, can easily be obtained by an expert on the subject, and it shall depend on the overall vehicle measurements. The above-stated preferred wheel measurements for an autonomous vehicle for farming in corrals could well be considered a reference for the rest of the vehicle measurements.

Whether the perimeter paddles (11) are integrally built in the disc perimeter (15) or connected in detachable fashion to the disc (15), for the invention herein to attain its full benefits, the climbing engagement wheel (10s) shall have at least one perimeter paddle (11), at least one radial lug (30), and such radial lug (30) shall be set up to achieve interference fit with the perimetral grooves (22) of an elevated barrier, such as the perimetral grooves in corrugated pipes (20), generally used as anti-migratory barriers. As a general notion, the radial lug (30), when the vehicle moves forward, can conveniently achieve interference fit with a groove in the elevated barrier on the terrain or equivalent object.

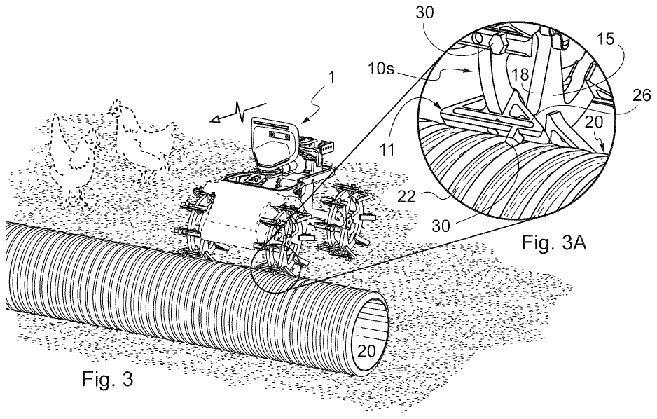

This beneficial structural feature of interference fitting, which can be observed in greater detail in FIGS. 3 and 4, and in the blown-up detail of FIG. 3A, allows the autonomous vehicle (1) to achieve surprising climbing action. The radial lug (30) engages in a groove generally parallel to the trajectory of the vehicle, in this case a corrugated pipe groove, and develops maximum traction to allow the vehicle to climb and effectively move across the elevated barrier on the terrain, whether it be a migration fence, conductor piping, or the like. Likewise, such radial lug (30) aids general vehicle traction at all times, as it can also be inserted in the terrain soil material, improving the autonomous vehicle traction (1). For example, any wheel pointed generally by numeral reference (10), and especially climbing engagement wheels (10s) or rear or traction wheels (10t), may include a set of radial lugs (30), preferably at least one radial lug in each perimeter paddle (11), thus improving traction and offering effective climbing capacity on elevated barriers (20) on the terrain, in particular, corrugated pipes that may serve as anti-migratory barriers in a corral.

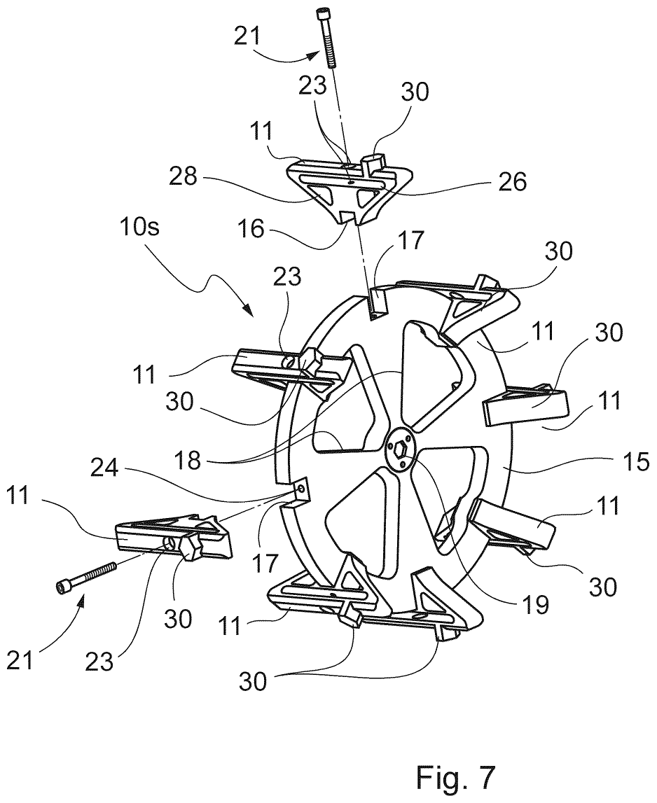

Upon observing the partial exploded view of a climbing engagement wheel (10s) according to the invention herein in FIG. 7, the preferred embodiment can be seen more in detail: the disc (15) has perforations (18) that reduce the weight of the wheel itself, which is an advantage. Also, said perforations (18) cut out as shown in the drawings, significantly contribute to reducing the amount of dirt and objects in the ground that usually get stuck to the sides of a disc as compared to the amount of dirt that would get stuck if the disc was not perforated.

In addition, the disc (15) has a central hexagonal-shaped bore (19) that can fit in a motor axis, e.g., from a motor. As those knowledgeable in the art shall understand, this type of engagement, as in a square or any similar fit, can secure a precise fit and adjustment, and sufficient power drive from a motor to the wheel.

A convenient and effective connection of the perimeter paddles (11) onto the disc (15), is by incorporating perimeter slots (17) on the disc that are intended to engage with the slots (16) in the perimeter paddles (11), thus forming a slot coupling. In order to secure the perimeter paddles (11), once they fit onto the disc (15), they can be tightened with screws (21) through the orifices (23) on the perimeter paddles (11) and through the appropriate threaded hole (24). In this manner, the perimeter paddles (11) can be attached and detached as desired. Also, the user of the autonomous vehicle (1) may modify the overall wheel design using various setups, for instance, choosing to connect more or fewer paddles on the disc periphery (15).

On the other hand, a skilled person will understand, the perimeter paddles (11) and the disc (15) may be connected in several ways: by interference fitting, fast coupling with levers, locknut threads and/or a combination of same. It is also possible to manufacture the wheels with the desired number of integrated paddles.

As illustrated in FIGS. 8A through 8E, perimeter paddles (11), according to the invention herein, may be designed differently, but every design must allow for interference fitting of the appropriate lug (30) in a groove into which it can be inserted. It will become apparent to skilled people in view of the teachings herein, that said design pattern must be respected to obtain the full benefits of the autonomous vehicle herein proposed.

FIG. 8A shows a preferred embodiment of the perimeter paddle (11) for the vehicle of the invention herein, depicted in the accompanying drawings by way of examples. In the first example for said perimeter paddle (11), the above-referenced radial lug (30) has been integrally built and positioned asymmetrically relative to the symmetry center of said paddle, that runs along the axis of the orifice (23), which shall generally be the vertical plane that shall coincide with the central plane of the disc (15) onto which the corresponding perimeter paddle (11) shall be mounted and it shall be aligned with the forward direction of the wheel in question.

FIG. 8A also shows a slot (16) intended for fitting against a perimeter slot (17) on the previously mentioned disc (15); this is for use where the paddles are detachable. In addition, the perimeter paddle (11) preferably includes relief orifices (28), which may be bored in several shapes and numbers, as convenient. Those skilled people shall appreciate in FIG. 8A that the reduction of weight and the use of material can be achieved by removing (i.e. emptying, perforating, piercing or hollowing out) material in the areas that are less compromised mechanically speaking, which means the resistance of the mechanical work shall be left to the periphery and the center.

Material removal techniques for weight relief without compromising the mechanical integrity of a part are widely known by the skilled person, who shall effortlessly interpret the different proposals for relief orifices (28) illustrated herein. Boring holes in a part or reducing its thickness can also contribute to its flexibility, as will be described below.

In FIGS. 8B to 8E, some example variations of perimeter paddles (11) and their combination with radial lugs (30) are shown. In some examples, like in FIG. 8D, the perimeter paddle (11) may include a detachable lug, which can be inserted or removed as convenient by screwing, adhesive, press-fitting, mechanical fitting, etc., without any limitation, since this does not constitute any technical difficulty for a skilled person. However, the preferred embodiment, according to the experience of the inventors, has been to integrally incorporate the lug into the paddle, which has proved to be a robust and reliable construction. This is why it is preferred, although non-limiting, for the aim of the invention herein.

Wherever soil tends to be loose, perimeter paddles (11) may be sharper in order to better penetrate the soil, as in FIG. 8C. If the terrain is more compact, paddles may be thicker in order to offer greater support surface, and so on. Perimeter paddles are indeed in the shape of a paddle oriented perpendicularly or transversely from the periphery of the wheel, having a front side and rear side.

As previously mentioned, the work environment for the autonomous vehicle (1) herein proposed is a challenging environment, mainly for the mobility of the vehicle itself. The soil may be covered with a layer of wood shavings, grain shells, small pieces of dry vegetables, which hampers grip and normal mobility of the wheels in a small vehicle intended to move within the enclosure.

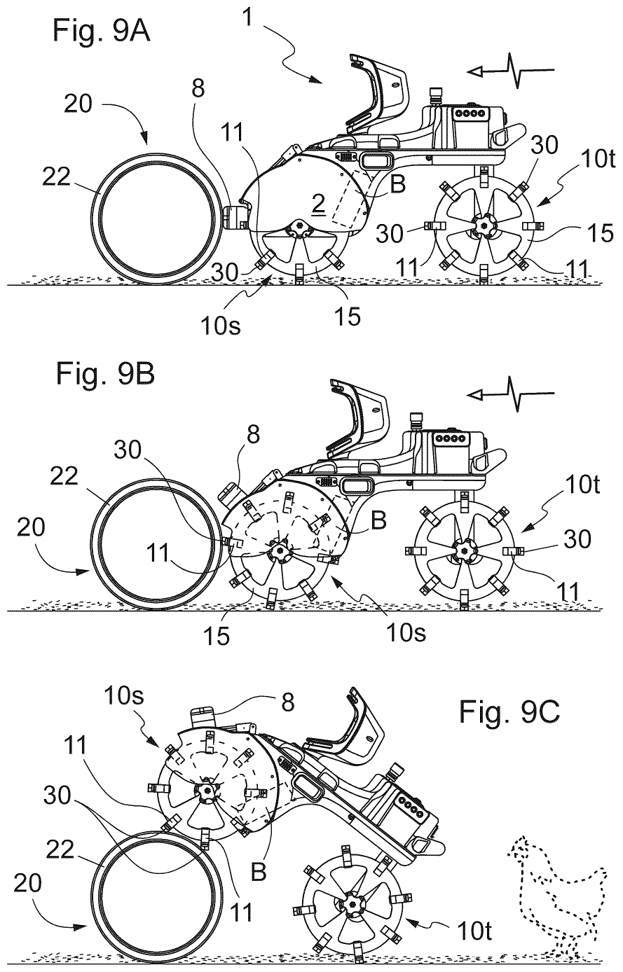

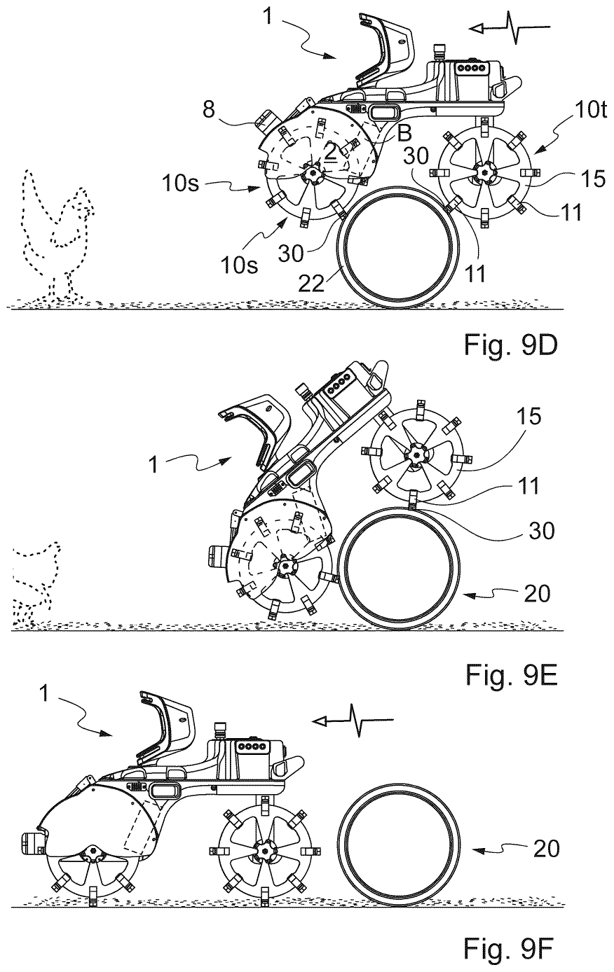

According to the invention herein, it is reasonable to establish that the dimensions of the autonomous vehicle (1) should be such that it enables its handling and maneuverability by the user, and the weight should be suitable for its work environment and to allow its manipulation. With this into consideration, the vehicle can include, for instance, grip handles for transportation. By reference, the width of the vehicle should be as reduced as possible, just enough so as to allow for the installation of two wheels and their respective motors, aligned side by side. Regarding vehicle length, it is convenient that the distance of separation between the exterior periphery of the front and rear wheels (10s, 10t) be shorter than the thickness of the object constituting the elevated barrier on the terrain; this shall allow the vehicle to climb effectively over it. A practical demonstration is seen in FIG. 9D.

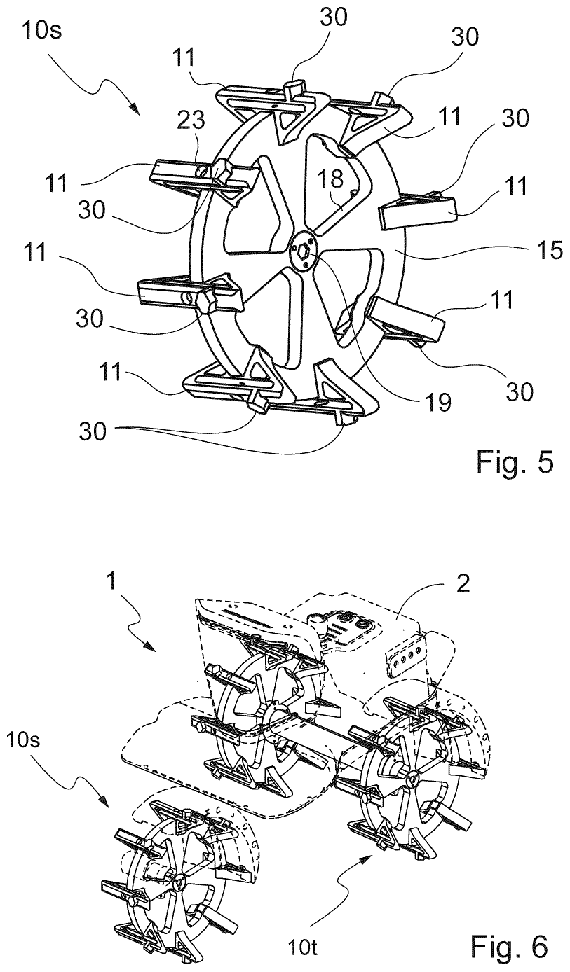

Next, some relevant considerations regarding the radial lug (30) will be made. FIGS. 3 and 4 illustrate the moment of active climbing use. It is illustrated in further detail in FIGS. 5 and 7, and different variations are illustrated in FIGS. 8A through 8E.

For the purpose the present invention, the radial lug (30) has the capacity to fit with interference into grooves; for the preferred case, these would be the perimetral grooves on corrugated pipes (20). This is possible given that said lug is placed on the periphery, where contact with the perimeter of the wheel itself (10) is established. For the purpose herein set forth, the main objective of a radial lug (30) is to aid traction of the vehicle, especially while climbing an elevated barrier on the terrain. It is worth noting that at least one wheel in the set of wheels should be a climbing engagement wheel (10s), and said climbing engagement wheel should have a set of perimeter paddles (11) distributed along its perimeter (10s). In turn, at least one of said perimeter paddles (11) includes a radial lug (30) having an interference fit geometry in order to engage into a seating groove (22) on an elevated barrier (20) on the terrain.

For the purpose herein set forth, a “climbing engagement wheel” (10s) as defined herein is a wheel with the capacity to face against an elevated barrier on the terrain and climb over it assisted by at least one of the above-mentioned radial lugs (30), given that radial lugs have proved to significantly increase traction capacity of the wheel on said elevated barrier on the terrain by way of a “clinging effect”, just as if it were a climber inserting his fingers into a crack in the rocks while climbing.

In the preferred embodiment examples of the invention herein, the lug is in the shape of an oblong hexagon, a sort of rhombus truncated on the front and rear ends, i.e. the ends that otherwise would protrude to the front and rear of the perimeter paddle are truncated in such manner that the narrower part of the geometry is towards the end that shall first come into contact with the elevated barrier on the terrain, for example, a corrugated pipe, and in particular with a seating groove (22) on the corrugated pipe (20) surface. For the purpose herein set forth, the perimeter paddles (11) and their respective radial lugs (30) shall preferably be reversible. Hence, it is convenient to use symmetrical lugs with tackle points to both ends of the lug, that is, said narrowing ends of the radial lug (30) towards the front and rear, if we consider the direction of the wheel. However, this shall be non-limiting as long as the shape of the radial lug (30) has the capacity to fit with interference into grooves. This is possible when the lug has a sharpened shape, i.e. parts that are narrower and wider, or chamfered, as shown in the figures by way of example, mainly so that the part of the lug that shall first come into contact with the barrier may push into the groove with its narrow end and, as the wheel continues to climb, the lug may fit with interference into it as its wider part gets inside the groove.

Therefore, considering that the radial lug (30) is structurally configured to fit with interference into a seating groove, the same, for example, may have a slope or chamfer that widens from the outer periphery towards the center of rotation of the wheel itself, i.e. as it approaches the paddle. An example of said chamfered shape can be seen in FIG. 8B, in a truncated cone with an oval base shape, among other options. Given the interference fit feature of the radial lug (30) into a grove, whichever the origin of the groove, if said groove is on the surface of the elevated barrier on the terrain (20), the autonomous vehicle shall have the capacity of fitting at least one radial lug (30) with interference in said at least one seating groove (22), in said elevated barrier on the terrain, achieving a surprising effect of gripping and climbing of the autonomous vehicle (1), allowing it to reliably cross over the barriers (20) placed in the passageways, without human assistance or supervision.

It could therefore be stated that the interference fit geometry of the radial lug (30) is selected from the group consisting of chamfered, beveled, tapered, conical, trapezoidal, rounded, oblong, hexagonal profiles, or combinations thereof, so as to obtain such interference fit geometry that fits or is driven into a seating groove running generally in the forward direction of the autonomous vehicle (1).

When the climbing of an elevated barrier (20) on the terrain is performed by an autonomous vehicle (1) which has two climbing engagement wheels (10s), as illustrated in FIGS. 3 and 4, the vehicle may run into, for example, a rather perpendicular corrugated pipe. One of the wheels may touch the pipe while the other wheel still needs to slightly spin in order for its radial lug to fit. This can easily be corrected by controlling the movement of the vehicle itself. This may also be the case when there is interference generated by debris on the floor or on the external surface of the corrugated pipe itself.

Generally, radial lugs (30) are designed and mounted so that they generally have a matching distance (between left wheel and right wheel) so that they are naturally prone to fit in the grooves, as illustrated in FIG. 4, i.e., so that each radial lug (30) effectively fits in the respective seating groove (22). This is perfectly possible when the distance between two lugs that are placed in the left climbing wheel and the right climbing wheel respectively is a multiple of the distance between two adjoining grooves, as in said FIG. 4, in a stroke perpendicular to the barrier, although this is not a limitation. As people skilled in the art shall understand, this shall depend on the steering mechanism used.

When certain elevated barriers on the terrain are incorporated in a corral, radial lugs (30) can be configured in an already pre-defined position in their respective paddles operating without inconveniences in a corrugated pipe or even admitting certain variations in pipe size and design, which are generally standard sizes. However, it is possible to improve even more the natural fit of the radial lugs (30) giving certain flexibility to the very same radial lugs (30) to allow slight sliding, displacement or side tilting, improving even more the radial lugs (30) fit.

Among the possibilities to grant more fitting flexibility to the radial lugs (30) are, for example, including a horizontal flexing slit (26) so that the lug may oscillate, and/or slide, and/or tilt, i.e., eventually bending laterally to fit conveniently even in various types of grooved pipes or surfaces.

As a skilled person can confirm, there are a variety of options to grant certain flexibility for lateral movement to radial lugs (30), either by selecting certain materials with elasticity to manufacture the perimeter paddles (11) or by using to certain geometries, carvings, hollowing out, and the use of geometry in general.

Said flexibility for movement, for the purpose herein set forth, could be called as accommodating capacity or auxiliary fit under extreme conditions, and can be attained by mechanisms as complex as desired, for example, with spring rails, elastic springs, or more or less complex geometries. A simple and effective solution is as illustrated in FIG. 8A, including a horizontal flexing slit (26), which in the example Figures is also supplemented by relief orifices (28), allowing for accommodation or convenient supplementary displacement of the lug to make it more effective.

### Crossing Maneuver of an Elevated Barrier on the Terrain

As shown in FIGS. 9A through 9F, the autonomous vehicle (1) may perform a crossing maneuver on an elevated barrier (20) on the terrain, and to such end, the control unit (U) includes commands set up so that when, for example, a camera (5) detects one of these barriers in front of the vehicle, once said barrier has been identified by shape, length and direction inside the corral, a crossing maneuver is activated. Regarding the inclusion of at least one camera (5) and other types of sensors that are convenient for the autonomous vehicle, these shall be described generally later on, only enough so that any person skilled in the art may understand the benefit of including them, and so that their inclusion does not imply any inconvenience from a technical point of view. Thus, they shall be merely mentioned, hereinafter focusing the disclosure precisely on approaching an elevated barrier on the terrain, such as a corrugated pipe and performing a crossing maneuver.

The crossing maneuver may start after having verified certain situations, i.e., as above mentioned it is possible to perform visual verification with cameras, analyzing geometric interpretation logic, or by running an image bank comparison of all kinds of barriers to be expected in the enclosure where the vehicle shall perform. In addition, a bumper sensor (8) can be added conveniently, which is a sort of front fender, that may also serve to gently push apart animals out of the way. Said bumper sensor (8) may be split into two parts, to detect, for example, a left/right collision, among other options. Thus, the vehicle can have direct feedback when it runs against an object while moving. It is worth noting that, for example, in case there is a bumper sensor (8) like the one shown in the drawings, an elevation actuator can be included such as a hydraulic cylinder (9) that shall allow to withdraw said bumper sensor (8), which also serves as a fender, from the front of the wheels so that the wheels can tackle and make full contact against the elevated barrier to be crossed.

By reference only, and to better comprehend how the autonomous vehicle herein crosses an elevated barrier such as a corrugated pipe or the like, FIGS. 9A through 9F have been included, where:

Firstly, in FIG. 9A, the autonomous vehicle (1) moving along a corral (in said figure, moving to the left), runs against the elevated barrier (20). In the case of having (a) bumper sensor(s) (8), and preferably using (the) upper camera(s) (5), it may verify that the object in front of it is indeed a surpassable barrier, by identifying object type, height, etc., resorting to the logic and functionalities processed by the control unit (U). Once it has identified the object as a surpassable elevated barrier, and in the case of having a bumper sensor (8), as FIG. 9B shows, said sensor bumper is pulled up, enabling the wheels to fully tackle the elevated barrier (20). Likewise, and in a non-limiting manner, the object can be detected in several ways. The vehicle could even formally lack a front fender or bumper sensor, or on the contrary, it could have a front one and a rear one, depending on the design needs. Notwithstanding the foregoing, an autonomous vehicle with wheels according to the invention herein shall be able to tackle an elevated barrier wherever necessary.

The motor(s) with which the autonomous vehicle (1) has been equipped is/are properly powered, preferably with the full wheel drive power available, for the vehicle to move forward against the elevated barrier (20), upon when the climbing engagement wheel(s) (10s) shall interact with the grooves, such as those on a corrugated pipe, by clinging at least one of the radial lugs (30) and shall effectively start climbing. As the vehicle climbs up, it accommodates and more and more radial lugs (30), in the case of multiple lugs, begin to fit with interference into the grooves.

As the vehicle wheels (10) continue to spin, they keep climbing until at some point the vehicle reaches the position shown in FIG. 9D, where the vehicle is completely on top of the elevated barrier (20). The paddles also contribute to maintain grip against the pipe and shall also contribute to even weight distribution in the vehicle, to allow firm hold of the autonomous vehicle (1), especially on its tackle area. The greater the weight on the tackle area, the more the vehicle shall tend to hold firm grip on the pipe and cross over it.

Once the vehicle has crossed over the top of the corrugated pipe (20) (i.e., the elevated barrier, for the purpose herein), the vehicle shall continue to move and descend, as illustrated in FIG. 9E. Clearly, as those skilled people understand, power drive to the wheels may vary during crossing, as most of the power is needed during the first half of the crossing maneuver, i.e. when the vehicle is effectively scaling or climbing.

Finally, the autonomous vehicle (1), as illustrated in FIG. 9F, having finished the crossing maneuver, continues moving and resumes its monitoring and labor tasks that require it to move along the corrals. The indication that the vehicle has overcome the obstacle may be obtained from different sensors, for example, tilt sensors, or by resorting to the programmed logic in the control unit (U), which includes routine checks for position, movement, inclination, and image collection via cameras.

By reference, it is important to establish that it is convenient that the total vehicle height be higher than the height of, for example, the tallest estimated height among the animals in the corral, in the case of a poultry farming corral. Only by reference, this would be the height of an adult chicken weighing approximately three kilograms, with a height of 30 cm (about 12 inches) tall. This is to prevent visual occlusion. Navigation data are gathered by one main camera (5), which is monocular and stereoscopic, and secondary cameras may or may not be included laterally.

Having described and illustrated the fundamentals of the present invention, additional characteristics of the autonomous vehicle (1) and its capacities shall now be described, as guidance for the reader and to fully understand all the beneficial consequences offered to the user by an autonomous vehicle such as the one proposed herein.

Monocular or stereoscopic cameras may be added to the head of the vehicle, as well as additional light fixtures. The head of the vehicle may rotate in relation to the vehicle by means of a motorized mechanism, a transmission system and a series of position sensors, all of which allow for greater versatility in capturing images, detecting objects and relative localization inside the corral.

In addition, the autonomous vehicle (1) may move following the instructions of a navigation system, which means that each one of the four motors, when the vehicle has four wheels and their respective motors, receives a speed indication according to the path and direction to take. For example, if the autonomous vehicle (1) needs to move forward, the right-side motors shall rotate clockwise at a certain speed while the left-side motors shall rotate anticlockwise at that same speed. If the autonomous vehicle (1) needs to change direction, for instance turn right, the right-side motors shall diminish their speed while the left side motors shall increase their speed, generating a differential action that shall result in a change of path. This way, the autonomous vehicle (1) has the capacity of moving forward, moving backwards, turning to either side, and even rotating 360 degrees using the differential power on each of the wheels. This differential drive system is especially useful to maneuver on irregular terrain. Also, the autonomous vehicle's (1) capacity for total rotation allows it to overcome obstacles and maneuver in reduced spaces with more ease.

Also, it is possible to add sensors that can record navigation data and may consist of a main camera performing as monocular and stereoscopic camera; secondary cameras that may or may not be installed on the sides; an inertial measuring unit (IMU), and rotary encoders in the wheels. In addition to these types of sensors, the autonomous vehicle (1) may have units to measure temperature and relative humidity and, for example, a laser sensor that measures soil temperature and humidity. The latter sensors make it possible to know and record the environmental conditions in the corral and detect potential problems. The main camera may have at least two high-resolution RGB lenses, a laser scanner and an infrared projector to improve lighting conditions. The camera may have the capacity to generate 3D information from 2D image processing by means of trigonometry formulas, which results in a tridimensional image expressed in what is commonly known as a point cloud. This information is essential to identify objects such as water piping and feeders, as well as walls, barriers or other obstacles in the way.

Also, the autonomous vehicle (1) may be constantly on alert searching for elements that may allow it to identify its location. With all this information, the navigation system may predict the corridors on which it can move, that are parallel to the longest side of the corral and maintain a general path following these lanes. The navigation system is designed to operate this way until reaching the end of the corrals, where it shall search for the perimeter walls for guidance and to choose another lane to move in the opposite direction. The type of trajectory on these lanes can be programmed as per the user's instruction, and it is possible to choose among different options, like running along the internal corral perimeters, scanning all the lanes, or running along the perimeter and the central area.

Another point of consideration is that there may exist obstructions due to extreme soil conditions in the corral, i.e., when the soil is very loose or muddy. This could cause loss of traction and involuntary stops. The problem when detecting an obstruction is that even though the autonomous vehicle (1) may be facing said obstruction, it may move to seek release, and the camera image may not be steady. Hence, a logical routine may be included for interpretation of camera images whereby after a period of time during which the physical references of the image do not change position or size by a minimal percentage value such as 10%, or the-visual or optical flow-odometer does not show changes, the navigation system shall read that there is an obstruction for the autonomous vehicle (1) and shall generate a series of maneuvers for its release.

These release maneuvers include specific differentials instructions for each motor on each wheel, to generate forward, reverse or lateral movements, until the odometer reads that the autonomous vehicle (1) has been capable of overcoming the obstruction and declares it has been released to navigate.

Therefore, the autonomous vehicle (1), which comprises a control unit (U) set up for specific agricultural farming tasks within a poultry farming enclosure, may connect operationally with at least one sensor of the group, which consists of a camera, a position sensor, a humidity sensor, a temperature sensor, a tilt sensor, a rechargeable power source (B) connected to at least said motor device (M), and said autonomous control unit (U).

Therefore, the above-described autonomous vehicle (1) may include all the aforementioned supplementary elements, which are absolutely compatible with the invention proposed herein, given that the performance of all those supplementary functions and elements is enhanced by the optimum vehicle performance when including specifically designed wheels, as per the following claims.

1. An autonomous vehicle (1) for farming labor within an animal farming enclosure, such as a poultry farming site, with the capacity of moving autonomously within said enclosure, where the enclosure has at least one elevated barrier (20) on the terrain, the autonomous vehicle comprising:
a chassis (3),
a control unit (U),
a plurality of wheels (10) supporting said chassis (3), wherein at least one wheel of said plurality of wheels is a climbing engagement wheel (10s),
at least one motor device (M) to power at least one of the wheels in said plurality of wheels,
wherein:
at least one climbing engagement wheel (10s) comprises:
a plurality of perimeter paddles (11) distributed along the perimeter of said climbing engagement wheel (10s), and
wherein at least one of said perimeter paddles (11) has a radial lug (30) with a geometry of interference fit into a seating groove (22) in said elevated barrier (20) on the terrain.

2. The autonomous vehicle as claimed in claim 1, wherein said elevated barrier (20) is a corrugated pipe and wherein said seating groove (22) is a perimetral groove on said corrugated pipe.

3. The autonomous vehicle as claimed in claim 1, wherein each one of the perimeter paddle (11) is detachably connected to a disc (15) in said wheel, and each radial lug (30) is detachably connected in each paddle.

4. The autonomous vehicle as claimed in claim 1, wherein each one of the radial lug (30) adopts for said geometry of interference fit a geometry selected from the group consisting of chamfered, beveled, tapered, conical, trapezoidal, rounded, oblong, hexagonal profiles, and combinations thereof.

5. The autonomous vehicle as claimed in any of claim 1, wherein each radial lug (30) adopts for said geometry of interference fit an oblong hexagon geometry, as a rhombus truncated on the front and rear ends.

6. The autonomous vehicle according as claimed in claim 1, further comprising:
a control unit (U) configured to perform specific farming tasks in the poultry farming enclosure, and operationally connected to at least one sensor of the group comprised of:
a camera,
a position sensor,
a humidity sensor,
a temperature sensor,
a tilt sensor,
a rechargeable power source (B) connected to at least one of such motor devices (M) and said autonomous control unit (U).
